(19) United States
(12) Patent Application Publication
(10) Pub. No.: US 2024/0313246 A1
(43) Pub. Date: Sep. 19, 2024

(54) ASSEMBLING METHOD FOR FUEL CELL STACK AND STACKING APPARATUS

(71) Applicant: Honda Motor Co., Ltd., Tokyo (JP)

(72) Inventors: Hiroshi Sekiguchi, Tokyo (JP); Kunihiko Yanagisawa, Tokyo (JP); Toru Ikeda, Tokyo (JP)

(21) Appl. No.: 18/587,601

(22) Filed: Feb. 26, 2024

(30) Foreign Application Priority Data
Mar. 16, 2023 (JP) 2023-042057

(51) Int. Cl. H01M 8/1004; H01M 8/10

(52) U.S. Cl. CPC H01M 8/1004; H01M 2008/1095

(57) ABSTRACT

An assembling method for a fuel cell stack including stacking alternately a unitized electrode assembly having an electrolyte membrane and an electrode, and a separator in a predetermined region to form a cell stacked body. Each of the unitized electrode assembly and the separator is a stack element, and the stacking includes transporting the stack element above the predetermined region while sucking the stack element by a suction portion, descending the stack element while positioning the stack element along a guide member extending upward around the predetermined region, and releasing a suction by the suction portion when a lower surface of the stack element abuts on an upper surface of another stack element having been stacked in the predetermined region.

### CROSS-REFERENCE TO RELATED APPLICATION

This application is based upon and claims the benefit of priority from Japanese Patent Application No. 2023-042057 filed on Mar. 16, 2023, the content of which is incorporated herein by reference.

### BACKGROUND OF THE INVENTION

### Field of the Invention

This invention relates to an assembling method for a fuel cell stack and a stacking apparatus capable of being used for assembling the fuel cell stack.

### Description of the Related Art

In recent years, technological developments have been made on a fuel cell that contribute to energy efficiency in order to ensure access to energy that is affordable, reliable, sustainable and advanced by more people. Conventionally, as a technology related to such a fuel cell, an assembling method for a fuel cell stack has been known in which a separator is suctioned via a suction pad provided on a robot hand, and then the separator is transported to a predetermined position and stacked by the robot. Such a method is described in, for example, Japanese Unexamined Patent Publication No. 2007-287436 (JP 2007-287436 A). In the assembling method described in JP 2007-287436 A, after a separator is abutted on an abutment member and positioned, the suction of the separator is released to drop the separator.

However, as the apparatus described in JP 2007-287436 A, in the method that the suction of the separator is released to drop the separator by free fall, in a case where the separator warps or undulates, the stacked position may be shifted, and the separator may be caught by an assembly shaft. As a result, stacking may be difficult.

### SUMMARY OF THE INVENTION

An aspect of the present invention is an assembling method for a fuel cell stack, including stacking alternately a unitized electrode assembly having an electrolyte membrane and an electrode, and a separator in a predetermined region to form a cell stacked body. Each of the unitized electrode assembly and the separator is a stack element, and the stacking includes transporting the stack element above the predetermined region while sucking the stack element by a suction portion, descending the stack element while positioning the stack element along a guide member extending upward around the predetermined region, and releasing a suction by the suction portion when a lower surface of the stack element abuts on an upper surface of another stack element having been stacked in the predetermined region.

Another aspect of the present invention is a stacking apparatus configured to form a stacked body by stacking a stack element in a predetermined region. The stacking apparatus includes a movable part provided vertically movably and including a suction portion configured to suck the stack element, a guide member extended upward around the predetermined region to regulate a position of an edge portion of the stack element when the movable part descends, an actuator ascending and descending the movable part, and an electronic control unit configured to control the suction portion and the actuator. The electronic control unit is configured to control the actuator so as to move the movable part to a target position where a lower surface of the stack element abuts on an upper surface of another stack element having been stacked in the predetermined region, and to control the suction portion so as to release sucking of the stack element when the movable part reaches the target position.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack assembled by using an assembling method for a fuel cell stack according to an embodiment of the present invention;

FIG. 2A is a plane view of a separator included in the fuel cell stack in FIG. 1;

FIG. 2B is a plane view of a unitized electrode assembly included in the fuel cell stack in FIG. 1;

FIG. 3 is a diagram for explaining a problem caused when the separator is stacked;

FIG. 4 is a side vies schematically showing a stacking apparatus according to the embodiment of the present invention;

FIG. 5 is a view taken along an arrow V in FIG. 4;

FIG. 6 is an enlarged cross-sectional view schematically illustrating a main configuration of a suction pad in FIG. 4;

FIG. 7A is a view illustrating a state where a undulation of the separator is corrected by suction of the suction pad;

FIG. 7B is a view illustrating a state where a warp of the separator is corrected by suction of the suction pad;

FIG. 8 is a block diagram illustrating a control configuration of the stacking apparatus according to the embodiment of the present invention;

FIG. 9A is a flowchart illustrating an example of processing performed by an ECU in FIG. 8;

FIG. 9B is a flowchart illustrating an example of processing following the processing in FIG. 9A;

FIG. 10A is a view illustrating an example of an operation of the stacking apparatus according to the embodiment of the present invention;

FIG. 10B is a view illustrating an example of an operation following the operation in FIG. 10A;

FIG. 10C is a view illustrating an example of an operation following the operation in FIG. 10B; and

FIG. 10D is a view illustrating an example of an operation following the operation in FIG. 10C.

### DETAILED DESCRIPTION OF THE INVENTION

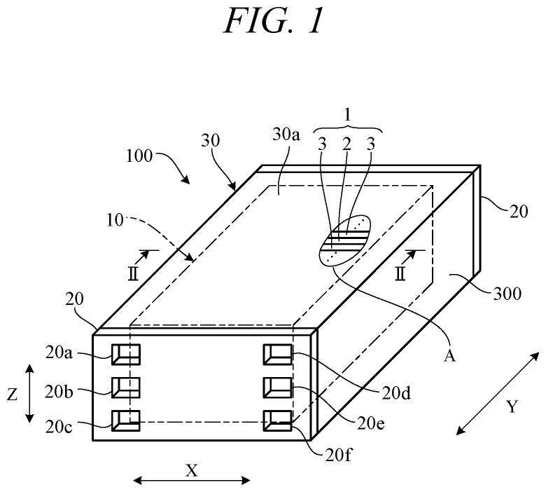

Hereinafter, an embodiment of the present invention will be described with reference to FIGS. 1 to 10D. FIG. 1 is a perspective view schematically showing a configuration of a fuel cell stack 100 assembled by using an assembling method for a fuel cell stack according to an embodiment of the present invention. The fuel cell stack 100 is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

In FIG. 1, for the sake of convenience, three-axis directions orthogonal to each other are shown as a front-rear direction, a left-right direction, and an up-down direction. The X-direction is a stacked direction of a plurality of cells which configure the fuel cell stack 100, and for example, corresponds to the front-rear direction, the left-right direction or the up-down direction of the vehicle. As illustrated in FIG. 1, the fuel cell stack 100 includes a cell stacked body 10, end units 20 disposed at both ends of the cell stacked body 10 in the Y-direction, and a case 30 surrounding the cell stacked body 10, and has a substantially rectangular parallelepiped shape as a whole.

The case 30 has four side walls 300 opposed to four side surfaces extending along the Y-direction of the cell stacked body 10, and is configured in a substantially box shape as a whole. Both end surfaces of the case 30 in the Y-direction are opened, and these open surfaces are covered with the end units 20. In “A” part of FIG. 1, a portion of the side wall 300 of the case 30 broken is shown. As illustrated in “A” part of FIG. 1, the cell stacked body 10 is configured by stacking a plurality of power generation cells 1 (for convenience, only a single cell 1 is illustrated) in the Y-direction. The power generation cell 1 includes a unitized electrode assembly (UEA) 2 having a joint body including an electrolyte membrane and an electrode, and separators 3 and 3 that are disposed on both sides in the Y-direction of the unitized electrode assembly 2 and sandwich the unitized electrode assembly 2. The unitized electrode assembly 2 and the separators 3 are alternately disposed in the Y-direction. The unitized electrode assembly 2 may be called a membrane electrode structural body.

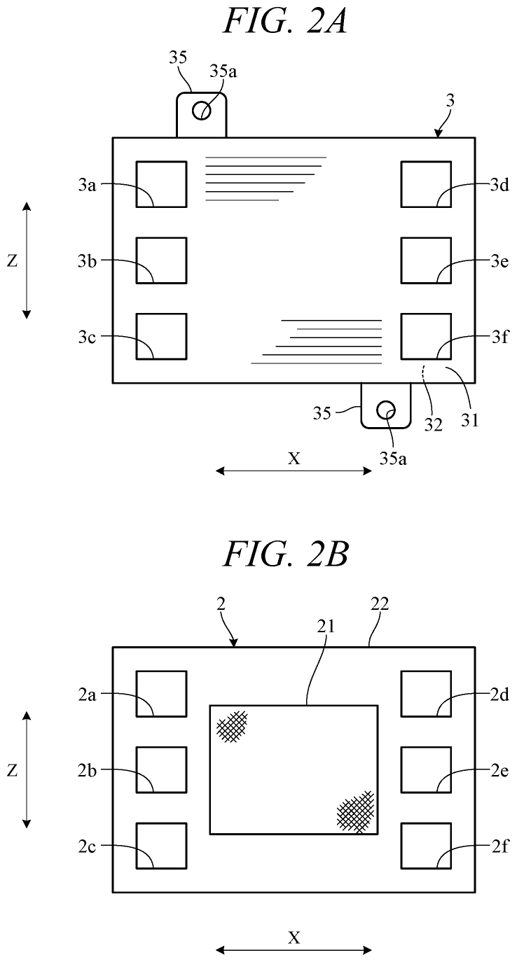

FIG. 2A is a plane view of the separator 3. As illustrated in FIG. 2A, the separator 3 includes a pair of front and rear metal thin plates 31 and 32 having a corrugated cross section, and is integrally formed by joining outer peripheral edges of the thin plates 31 and 32. For the separator 3, a conductive material having excellent corrosion resistance is used, and for example, titanium, a titanium alloy, stainless steel, or the like can be used. The pair of thin plates 31 and 32 are formed in an uneven shape by press-molding or the like so that a cooling flow path through which a cooling medium (for example, water) flows is formed inside the separator 3 (between the pair of thin plates 31 and 32), and a power generation surface of the power generation cell 1 is cooled by the flow of the cooling medium.

By forming the surface of the thin plate 31 in uneven shape, an anode flow path through which a fuel gas containing hydrogen flows is formed along the X-direction between the thin plate 31 of the separator 3 and the unitized electrode assembly 2. By forming the surface of the thin plate 32 in uneven shape, a cathode flow path through which an oxidant gas containing oxygen flows is formed along the X-direction between the thin plate 32 of the separator 3 and the unitized electrode assembly 2.

At one end portion and the other end portion of the separator 3 in the X-direction, a plurality of through-holes 3a to 3c and 3d to 3f penetrating the separator 3 are opened side by side in the Z-direction. Tabs 35 made of resin are joined to one end portion and the other end portion of the separator 3 in the Z-direction by welding, brazing, or the like, and the tabs 35 are protruded from edge portions of the separator 3 toward one side and the other side in the Z-direction, respectively. The tab 35 has a substantially rectangular shape in a plan view, and a through-hole 35a for positioning the separators 3 at the time of stacking is opened at a central portion the tab 35. The pair of tabs 35 are provided at different positions in the X-direction.

FIG. 2B is a plane view of the unitized electrode assembly 2. As illustrated in FIG. 2B, the unitized electrode assembly 2 includes a membrane electrode assembly (MEA) 21 having a substantially rectangular shape and a frame 22 made of resin supporting a peripheral edge of the membrane electrode assembly 21. The membrane electrode assembly 21 includes an electrolyte membrane, an anode electrode provided oppositely to the anode flow path on one side in the Y-direction of the electrolyte membrane and a cathode electrode provided oppositely to the cathode flow path on the other side in the Y-direction of the electrolyte membrane. The electrolyte membrane is, for example, a solid polymer electrolyte membrane. The anode electrode has a catalyst layer formed on one surface of the electrolyte membrane and a gas diffusion layer formed on an outer side of the catalyst layer. The cathode electrode also has a catalyst layer formed on the other surface of the electrolyte membrane and a gas diffusion layer formed on an outer side of the catalyst layer.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the unitized electrode assembly 2.

At one end portion and the other end portion of the unitized electrode assembly 2 in the X-direction, a plurality of through-holes 2a to 2c and 2d to 2f penetrating the frame 22 are opened side by side in the Z-direction. The through-holes 2a to 2f are provided so as to communicate with the through-holes 3a to 3f of the separator. In forming the cell stacked body 10 (FIG. 1), a single unitized electrode assembly 2 is joined integrally to a single separator 3 by welding, bonding, or the like, and a set of unit cell is formed in advance. Then, a plurality of the unit cells are stacked. Therefore, unlike the separator 3, the frame 22 of the unitized electrode assembly 2 is not provided with a tab for positioning at the time of stacking.

Although not shown, each of the end units 20 disposed on one side and the other side in the Y-direction includes a terminal plate disposed on the outside of the cell stacked body 10 in the Y-direction, an insulating plate disposed on the outside of the terminal plate in the Y-direction, and an end plate disposed on the outside of the insulating plate in the Y-direction. The terminal plate is a substantially rectangular plate-shaped member made of metal, and has a terminal portion for extracting electric power generated by an electrochemical reaction in the cell stacked body 10. The insulating plate is a substantially rectangular plate-shaped member made of non-conductive resin or rubber, and electrically insulates the terminal plate from the end plate. The end plate is a plate-shaped member made of metal or resin having high strength.

At one end portion and the other end portion in the X-direction of the end unit 20 on one side in the Y-direction, a plurality of through-holes 20a to 20c and 20d to 20f penetrating the end unit 20 are opened side by side in the Z-direction. The through-hole 20a is a through-hole for supplying the fuel gas into the cell stacked body 10. The through-hole 20b is a through-hole for discharging the cooling medium out of the cell stacked body 10. The through-hole 20c is a through-hole for discharging the oxidant gas out of the cell stacked body 10. The through-hole 20d is a through-hole for supplying the oxidant gas into the cell stacked body 10. The through-hole 20e is a through-hole for supplying the cooling medium into the cell stacked body 10. The through-hole 20f is a through-hole for discharging the fuel gas out of the cell stacked body 10.

A plurality of flow paths (manifolds) extending in the Y-direction so as to communicate with the through-holes 20a to 20f are formed at both end portions of the cell stacked body 10 in the X-direction. These flow paths are formed by a collection of through-holes 3a to 3f and 2a to 2f in FIGS. 2A and 2B. The fuel gas and the oxidant gas as a reaction gas are supplied to the anode flow path and the cathode flow path inside the cell stacked body 10 via these flow paths, and power is generated in the power generation cells 1. In addition, the cooling medium is supplied to the cooling flow path inside the cell stacked body 10, and the power generation surface is cooled. Although not shown, through-holes are opened at positions corresponding to the through-holes 35a of the tabs 35 in the pair of end units 20.

An assembling method for the fuel cell stack 100, which is configured as described above, will be schematically described as follows. First, the end unit 20 on one end side in the Y-direction is mounted on the assembly table along assembly shafts that protrude upward from the assembly table. Then, a predetermined number of the separators 3 and the unitized electrode assemblies 2 are alternately stacked above the end unit 20 (stacking step). More specifically, a single separator 3 and a single unitized electrode assembly 2 are joined together beforehand to form a set of unit cell (joining step), and a predetermined number of sets of unit cells are stacked, while the assembly shafts are inserted into the through holes 35a of the tabs 35 of such a unit cell (the separator 3) to position the unit cell. At the end of stacking step, the end unit 20 on the other end side in the Y-direction is stacked, a stacked body before pressurization is formed, accordingly.

Next, pressurizing force is applied to the stacked body from above by using a pressurizer to compress the stacked body in a stacked direction (pressurizing step). When the length between the pair of upper and lower end units 20 becomes a predetermined length, a coupling member is fastened to the end unit 20 with a bolt so that the length between the end units 20 is maintained at the predetermined length, while a compression load is being applied to the stacked body. For example, both upper and lower end portions of the case 30, as the coupling member, are fixed to the pair of upper and lower end units 20 (fastening step). Thus, the cell stacked body 10 having a predetermined length is formed. Next, the entirety including the cell stacked body 10 is lifted up to detach the cell stacked body 10 from the assembly shaft (detaching step). Finally, the fuel cell stack 100 is sealed from the outside by closing the through holes for the assembly shafts that are drilled in the end unit 20.

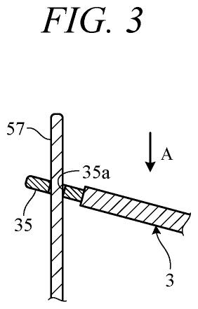

The separator 3 is made up of a thin plate, by the way, and thus, warpage or undulation may occur in the entire separator. In addition, the tab 35, which is joined to the separator 3, may be bent. In such a case, as illustrated in FIG. 3, the through-hole 35a of the tab 35 and the assembly shaft 57 are not parallel to each other. Hence, the through-hole 35a of the tab 35 may be caught by the assembly shaft 57 in the stacking step, and a smooth movement (movement in an arrow A direction) of the separator 3 (the unit cell) may not be made. Therefore, the present embodiment is configured as follows so that the unit cell can be stacked smoothly.

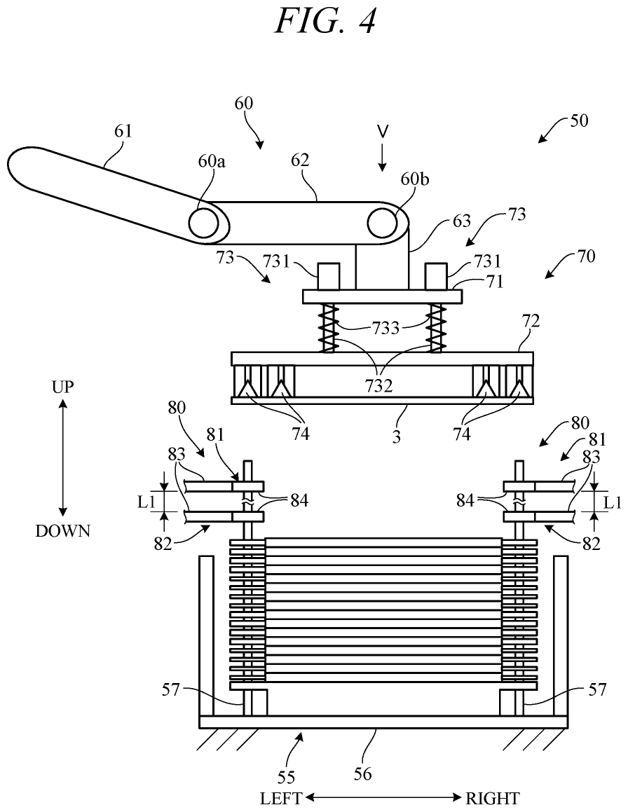

The assembling method for the fuel cell stack 100 according to the present embodiment has a characteristic in the stacking step, in particular. The unit cell is stacked by use of a stacking apparatus. FIG. 4 is a diagram schematically illustrating an overall configuration of a stacking apparatus 50 according to an embodiment of the present invention. Hereinafter, an up-down direction and a left-right direction are defined as illustrated in the drawing, and the configuration of each unit will be described according to this definition. The down direction is a gravity direction, and the up-down direction corresponds to a stacked direction of the power generation cell 1, that is the Y-direction (stacked direction) in FIG. 1. The left-right direction corresponds to the Z-direction in FIG. 1.

As illustrated in FIG. 4, the stacking apparatus 50 includes: an assembly table 55; a robot 60, which operates above the assembly table 55; a suction unit 70, which is attached to the robot 60; and a pair of left and right grip devices 80, which are provided on left and right sides of the assembly table 55. FIG. 4 illustrates a state in which the suction unit 70 is located above the grip devices 80, and the separator 3 is sucked by the suction unit 70. Hereinafter, the separator 3 to be stacked by using the stacking apparatus 50, that is, the separator 3 to be stacked will be referred to as a workpiece, in some cases.

The assembly table 55 includes a base 56 disposed substantially horizontally, and a pair of left and right assembly shafts 57 extending upward from an upper surface of the base 56. The assembly shaft 57 has a substantially cylindrical shape, and the diameter of its upper end portion gradually decreases upward. This enables the assembly shaft 57 to be easily inserted into the through-hole 35a of the tab 35.

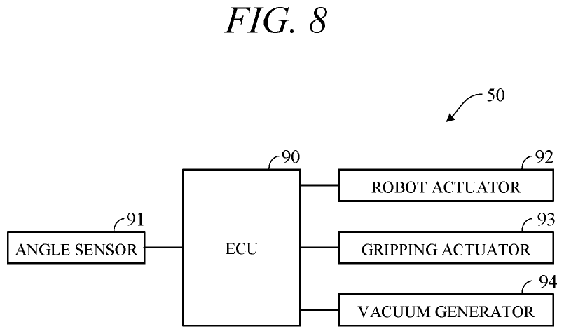

The robot 60 is an articulated industrial robot including arms 61 and 62, and a hand 63 provided at a tip end portion of the arm 62. The arm 61 and the arm 62 are pivotally coupled with each other through a pivot shaft 60a, and the arm 62 and the hand 63 are pivotally coupled with each other through a pivot shaft 60b. The configuration of the robot 60 (the number of arms and the like) is not limited to the illustrated one. The arms 61 and 62 and the hand 63 are pivoted by driving of a robot actuator such as a servo motor provided on the pivot shafts 60a and 60b, for example. The position and attitude of the hand 63 are changed, accordingly. The robot actuator is controlled by an ECU (FIG. 8).

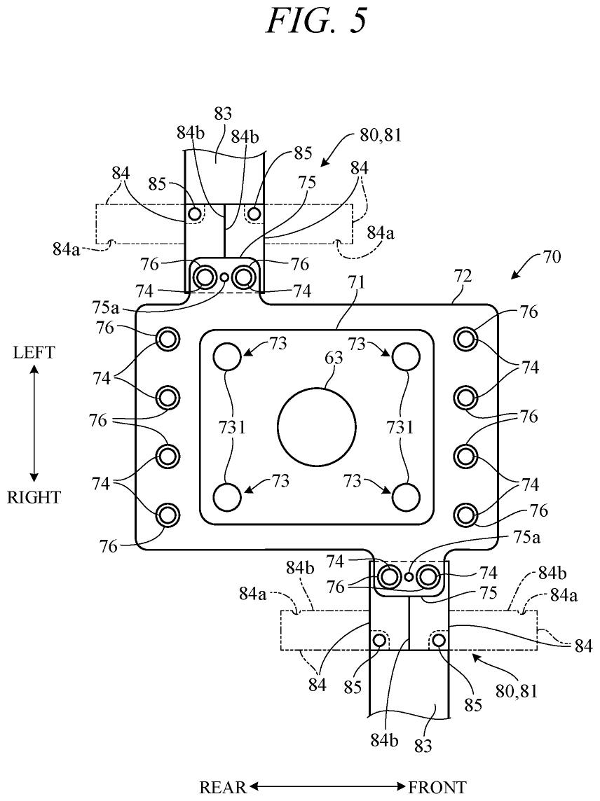

FIG. 5 is a diagram of the suction unit 70, when viewed from above (when viewed from an arrow V of FIG. 4). As illustrated in FIGS. 4 and 5, the suction unit 70 includes: a base plate 71 fixed to the hand 63; a movable plate 72 disposed substantially parallel to the base plate 71 below the base plate 71; a plate support portion 73, which supports the movable plate 72 from the base plate 71; and a plurality of suction pads 74, which are supported by the movable plate 72.

As illustrated in FIG. 5, the base plate 71 has a substantially rectangular shape in a plan view, and its central portion is fixed to the hand 63. The movable plate 72 has a substantially rectangular shape in a plan view that is larger by one size than the base plate 71, both front and rear end portions of the movable plate 72 protrude outward in the front-rear direction relative to the base plate 71, and both left and right end portions of the movable plate 72 protrude outward in the left-right direction relative to the base plate 71. The shape of the peripheral edge of the movable plate 72 is substantially identical to the shape of the peripheral edge of the separator 3 (FIG. 2A). Therefore, similarly to the tabs 35 of the separator 3, protrusion portions 75, which protrude in the left-right direction, are respectively provided in both left and right end portions of the movable plate 72. Similarly to the tab 35, a through-hole 75a is provided in the up-down direction in the protrusion portion 75.

As illustrated in FIGS. 4 and 5, the plate support portion 73 is provided in the vicinity of each of four corners of the base plate 71. The plate support portion 73 includes: cases 731, which protrude upward from an upper surface of the base plate 71; rods 732, which penetrate through the base plate 71, and which extend in up-down direction; and springs 733, which are interposed between the base plate 71 and the movable plate 72. The case 731 has a tubular body with an upper surface closed and a lower surface open.

A lower end portion of the rod 732 is fixed to the movable plate 72, and an upper end portion thereof is inserted into the case 731 so as to be movable in the up-down direction. Although not illustrated, the plate support portion 73 is provided with a movement restriction portion (a downward movement restriction portion, an upward movement restriction portion) that restricts upward and downward movements of the rod 732 so that the upper end portion of the rod 732 does not move to the outside of the case 731. The movement restriction portion can be configured with, for example, a rod-side protrusion that protrudes from an outer circumferential surface of the rod 732, and a case-side protrusion that protrudes from two upper and lower positions of an inner peripheral surface of the case 731. That is, the rod-side protrusion is disposed between the upper and lower case-side protrusions, and the rod-side protrusion abuts on the case-side protrusion, so that the movement of the rod 732 in the up-down direction can be restricted. The rod 732 is pulled downward at an initial time due to the gravity of the movable plate 72, and is in an initial position that has moved downward to the maximum in the case. The configuration of the movement restriction portion is not limited to the one that has been described above.

The spring 733 is, for example, a coil spring (more specifically, a compression coil spring) provided to surround the rod 732. A lower end surface of the spring 733 abuts on an upper surface of the movable plate 72, and an upper end surface thereof abuts on a lower surface of the base plate 71. Accordingly, the movable plate 72 is supported to be movable in the up-down direction from the base plate 71 via the rod 732 and the spring 733, and the base plate 71 and the movable plate 72 are capable of getting closer to each other while compressing the spring 733.

As illustrated in FIG. 5, the suction pads 74 are attached to the movable plate 72 on the outer side in the front-rear direction and the outer side in the left-right direction of the base plate 71. More specifically, a plurality of (four in the drawing) suction pads 74 are provided in both end portions in the front-rear direction of the movable plate 72 in alignment with one another in the left-right direction, and a pair of front and rear suction pads 74 are provided in each of the left and right protrusion portions 75 with the through-hole 75a interposed therebetween. The arrangement of the suction pads 74 is not limited to this, and the suction pad 74 may be additionally provided in both left and right end portions (other than the protrusion portion 75) of the movable plate 72.

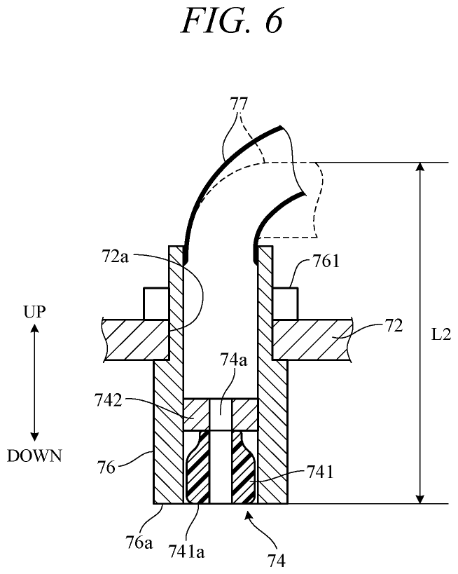

FIG. 6 is a cross-sectional view schematically illustrating a configuration of the suction pad 74. As illustrated in FIG. 6, the suction pad 74 includes: a pad portion 741 having a substantially cylindrical shape; and a pad support portion 742 having a substantially ring shape to which an upper end portion of the pad portion 741 is fixed. The pad portion 741 is made of a member having elasticity, such as rubber or resin. The pad support portion 742 is made of, for example, metal.

A pipe 76, which is made of metal and which has a substantially cylindrical shape, is disposed around the suction pad 74 to surround the suction pad 74. An outer circumferential surface of the pipe 76 is formed in a stepped shape such that an upper portion has a smaller diameter than that of a lower portion, and a screw portion is provided on the outer circumferential surface of the upper portion of the pipe 76. A through-hole 72a is opened in the movable plate 72. The through-hole 72a is, for example, a screw hole, and an upper end portion of the pipe 76 is screwed into the screw hole, and protrudes upward from the through-hole 72a. A nut 761 is screwed onto the outer circumferential surface of the pipe 76, and thus the pipe 76 is fixed to the movable plate 72. Piping 77 is connected with the upper end portion of the pipe 76 through a joint, not illustrated.

The pad support portion 742 of the suction pad 74 is hermetically fixed to an inner circumferential surface of the pipe 76. For example, a screw portion is provided on each the outer circumferential surface of the pad support portion 742 and the inner circumferential surface of the pipe 76, the pad support portion 742 is screwed to a predetermined position, then the circumferential surfaces are sealed together, and the pad support portion 742 is fixed to the pipe 76. The pad support portion 742 may be fixed to the inner circumferential surface of the pipe 76 by welding or the like, or may be fixed to the inner circumferential surface through a sealing material. The upper end portion of the pipe 76 may be fixed to the lower surface of the movable plate 72 without passing through the through-hole 72a. In this case, the pad support portion 742 may be configured to pass through the through-hole 72a of the movable plate 72 and seal a surrounding of the through-hole 72a, and in addition, an upper end portion of the pad support portion 742 may be fixed to the movable plate 72 with the nut 761 or the like.

The outer circumferential surface of the pad portion 741 of the suction pad 74 has a smaller diameter than that of the outer circumferential surface of the pad support portion 742, and there is a gap between the outer circumferential surface of the pad portion 741 and the inner circumferential surface of the pipe 76. A lower end surface of the pad portion 741 is a suction surface 741a, and the suction surface 741a is positioned on an identical plane to a lower end surface (a tip end surface) 76a of the pipe 76. In the inside of the suction pad 74, an internal passage 74a, which penetrates through the entire suction pad in the up-down direction, is provided from an upper end surface of the pad support portion 742 to the suction surface 741a. The internal passage 74a communicates with a vacuum generator through the pipe 76 and the piping 77.

The outer circumferential surface of the pad portion 741 of the suction pad 74 has a smaller diameter than that of the outer circumferential surface of the pad support portion 742, and there is a gap between the outer circumferential surface of the pad portion 741 and the inner circumferential surface of the pipe 76. A lower end surface of the pad portion 741 is a suction surface 741a, and the suction surface 741a is positioned on an identical plane to a lower end surface (a tip end surface) 76a of the pipe 76. In the inside of the suction pad 74, an internal passage 74a, which penetrates through the entire suction pad in the up-down direction, is provided from an upper end surface of the pad support portion 742 to the suction surface 741a. The internal passage 74a communicates with a vacuum generator through the pipe 76 and the piping 77.

FIG. 6 illustrates the piping 77 (solid lines), which communicates with the suction pad 74 disposed in both front and rear end portions of the movable plate 72, and the piping 77 (dotted lines), which communicates with the suction pad 74 disposed in the protrusion portion 75 of the movable plate 72. In the protrusion portion 75, in order to avoid interference with the grip device 80 to be described later, a height from the suction surface 741a of the suction pad 74 (the lower end surface 76a of the pipe 76) to an upper end portion of the piping 77 is set to a predetermined length L2. The piping 77 may be attached to a side end surface of the pipe 76, and in such a case, the height from the suction surface 741a to the upper end portion of the pipe 76 is set to the predetermined length L2. When the vacuum generator is activated (turned on) to bring the internal passage 74a into a vacuum state, suction force acts on the workpiece (the separator 3), thereby enabling the workpiece to be sucked. When the vacuum generator is deactivated (turned off), the suction force is removed, thereby enabling the workpiece to be detached from the suction surface. Turning on and off the vacuum generator includes opening and closing an electromagnetic valve provided partway in a flow path that connects the vacuum generator with the internal passage 74a. Turning on and off the vacuum generator (for example, opening and closing the electromagnetic valve) is controlled by the ECU (FIG. 8).

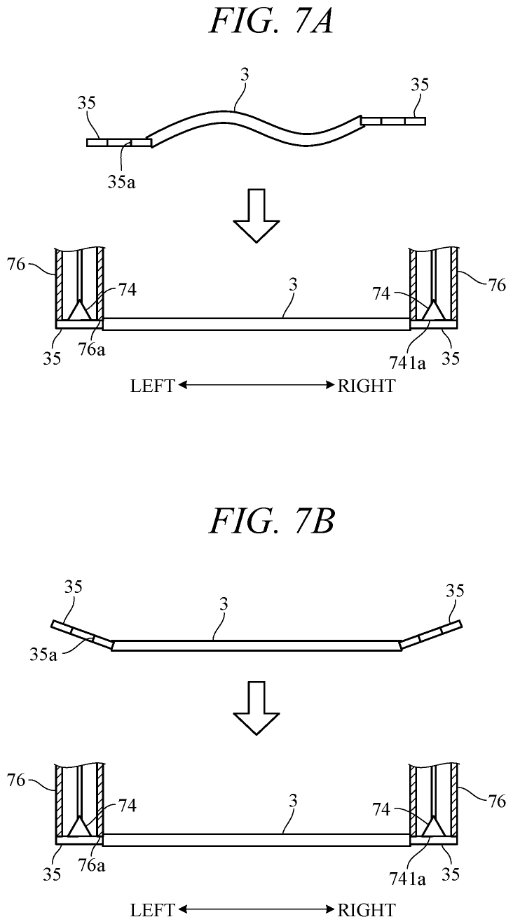

In the present embodiment, the pipe 76 made of metal is provided around the suction pad 74. Therefore, it becomes possible to correct deflection such as warpage or undulation of the separator 3, when the separator 3 (the workpiece) is sucked by the suction pad 74. For example, as illustrated in FIG. 7A, in a case where the separator 3 undulates, when an upper end surface of the tab 35 is sucked by the suction pad 74, the upper end surface of the tab 35 is brought into close contact with the entire surface of the lower end surface 76a of the pipe 76 by the suction force. In addition, as illustrated in FIG. 7B, also in a case where the separator 3 warps, when the upper end surface of the tab 35 is sucked by the suction pad 74, the upper end surface of the tab 35 is brought into close contact with the entire surface of the lower end surface 76a of the pipe 76 by the suction force.

Accordingly, the warpage and undulation of the separator 3 are corrected, and the upper end surfaces of the left and right tabs 35 are positioned on an identical horizontal plane. As a result, the separator 3 is in a uniformly horizontal attitude as a whole. This makes the through-hole 35a of the tab 35 and the assembly shaft 57 parallel to each other. Therefore, unlike FIG. 3, it becomes possible to smoothly insert the assembly shaft 57 into the through-hole 35a of the tab 35 of the separator 3 from above the assembly shaft 57. As illustrated in FIG. 5, the suction pads 74 are provided on the peripheral edge portions of the movable plate 72, but the pair of suction pads 74 are provided to be close to each other with the through-hole 75a interposed therebetween, in the position corresponding to the tab 35 of the separator 3. Therefore, it is possible to exert strong correction force on the tab 35 to have a horizontal attitude, so that the through-hole 35a and the assembly shaft 57 can be prevented from being caught on each other.

As illustrated in FIG. 4, each of the pair of left and right grip devices 80 includes an upper grip 81, and a lower grip 82 disposed below the upper grip 81 by a predetermined distance L1. The upper grip 81 and the lower grip 82 respectively have the same configurations. FIG. 5 illustrates a plan view of the pair of left and right upper grips 81 as the grip devices 80. A plan view of the lower grip 82 is also identical to the one illustrated in FIG. 5. The predetermined distance L1 is longer than the predetermined length L2 in FIG. 6, and it is possible to dispose the suction unit 70 (the suction pad 74, the pipe 76, and the piping 77) between the upper grip 81 and the lower grip 82.

As illustrated in FIG. 5, the grip device 80 includes: a bracket 83, which is fixedly disposed on the outside of the suction unit 70 in the left-right direction; and a pair of front and rear levers 84, which protrude inward in the left-right direction from the bracket 83. The lever 84 has a substantially rectangular parallelepiped shape, and is pivotally supported at an end portion of the bracket 83 with a pin 85 extending in the up-down direction. The solid lines in FIG. 5 indicate a closed position (a closed attitude) of the lever 84. In the closed position, end surfaces 84b of the pair of levers 84 abut on each other. The end surface 84b is a grip surface for gripping the assembly shaft 57 (FIG. 4), and the grip surface 84b is provided with a recessed portion 84a having a substantially semicircular shape or a substantially triangular shape in the up-down direction to correspond to the position and shape of the assembly shaft 57. In the closed position, the assembly shaft 57 is sandwiched and held in the inside of the pair of recessed portions 84a.

FIG. 8 is a block diagram showing a control configuration of the stacking apparatus 50. As illustrated in FIG. 8, the stacking apparatus 50 includes an ECU 90, and an angle sensor 91, a robot actuator 92, a gripping actuator 93 and a vacuum generator 94 which are connected communicably to the ECU 90.

The angle sensor 91 detects each of rotational angles at the pivot shafts 60a and 60b of the robot 60, and is configured by a rotary encoder or a resolver. The position and posture of the hand 63 can be detected (calculated) based on signal from the angle sensor 91, and thus the position and posture of the base plate 71 integral with the hand 63 can be detected.

The ECU 90 is an electronic control unit configured to include a computer including an arithmetic processing unit, such as a CPU, a storage unit, such as a ROM or RAM, and other peripheral circuits. The ECU 90 detects (calculates) a current position of the suction unit 70, for example, the position of the suction surface 741a of the suction pad 74, based on the signal from the angle sensor 91. Then, the ECU 90 controls the robot actuator 92 and the gripping actuator 93 based on the current position of the suction surface 741a, and turn on or off the vacuum generator 94. In the on-off control of the vacuum generator 94, the opening and closing control of the solenoid valve provided in the middle of the flow path connecting the vacuum generator 94 and the internal passage 74a of the suction pad 74.

With regard to detecting the position of the suction surface 741a, the positional relation (relative distance in three axial directions from the hand 63 to the suction surface 741a) between the hand 63 of the robot 60 and the suction surface 741a is stored in advance in a memory of the ECU 90. Then, the ECU 90 calculates a three-dimensional position from a reference point of the hand 63 of the robot 60 (e.g., a center point of the upper surface of the base 56) based on the signal from the angle sensor 91, and by adding a relative distance from the hand 63 to the suction surface 741a, which is stored in advance, to the three-dimensional position, detects the position of the suction surface 741a with respect to the reference point, that is, the initial position at which the rod 732 is moved to maximum downward in the case 731. The position of the suction surface 741a includes a height from the base 56 to the suction surface 741a.

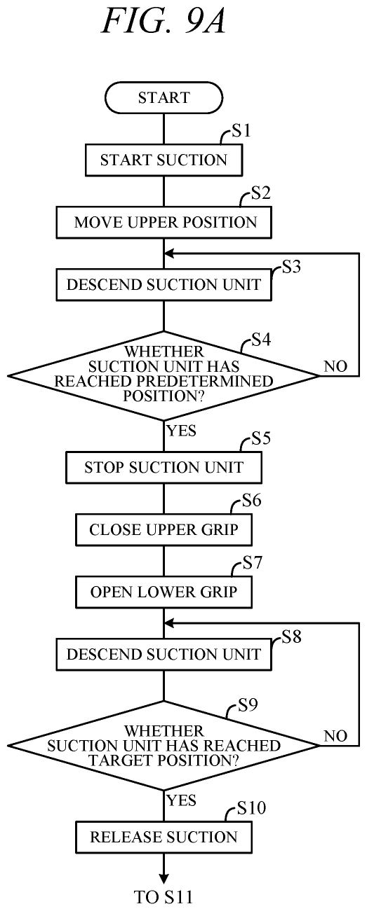

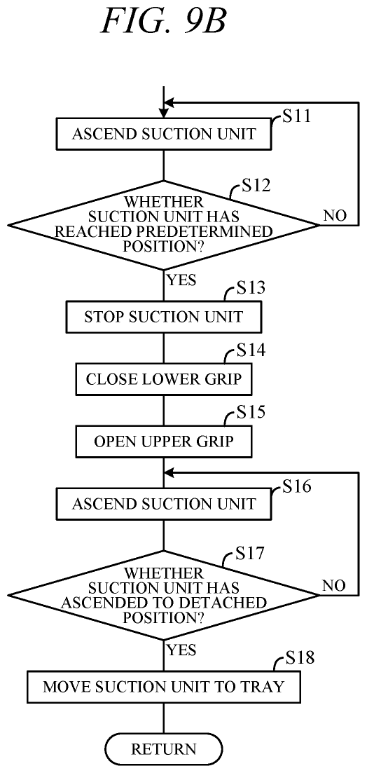

FIGS. 9A and 9B are flowcharts illustrating an example of processing to be performed by the ECU 90 in accordance with a predetermined program. The processing illustrated in this flowchart is started, for example, after the end unit 20 is mounted on the upper surface of the base 56, when an instruction is given to stack a unit cell (a set of the unitized electrode assembly 2 and the separator 3), and is repeated until stacking of a predetermined number of unit cells ends. At an initial point in time when the processing is started, the upper grip 81 of the grip device 80 is opened, and the lower grip 82 is closed. In addition, at the initial point in time, the suction unit 70 is located in the initial position. In the initial position, the suction unit 70 is located above a tray (not illustrated) in which a plurality of sets of unit cells to be stacked are stored. The unit cell to be stacked is configured by integrating the single unitized electrode assembly 2 with the single separator 3 beforehand by welding or the like (the joining step).

As illustrated in FIG. 9A, first, the ECU 90 turns on the vacuum generator 94 in step S1. This causes the suction force to act on the suction pad 74, and the separator 3 (the unit cell) is sucked. More specifically, the separator 3 is sucked in a state in which the position of the through-hole 75a of the protrusion portion 75 of the movable plate 72 coincides with the position of the through-hole 35a of the tab 35 of the separator 3. In this situation, the upper surface of the separator 3 (such as the upper end surface of the tab 35) is brought into close contact with the lower end surface 76a of the pipe 76, and thus undulation and warpage of the separator 3 are corrected (FIGS. 7A and 7B). This enables the entire separator to be held in a horizontal attitude.

Next, in step S2, the ECU 90 outputs a control signal to a robot actuator 92, and moves the suction unit 70 to a predetermined start descending position, while grasping the current position of the suction unit 70 (for example, the suction surface 741a), based on a signal from an angle sensor 91 (transporting step). The start descending position is, for example, the position illustrated in FIG. 4. At the start descending position, the through-hole 35a of the tab 35 of the separator 3 that has been sucked is located above the assembly shaft 57. More specifically, the center lines of the through-hole 35a and the through-hole 75a are positioned on an extension line of the center line of the assembly shaft 57. Next, in step S3, the ECU 90 outputs a control signal to the robot actuator 92, and causes the suction unit 70 to descend with the position of the suction unit 70 (the suction pad 74) kept constant in the front-rear direction and the left-right direction, while grasping the current position of the suction unit 70, based on the signal from the angle sensor 91 (descending step).

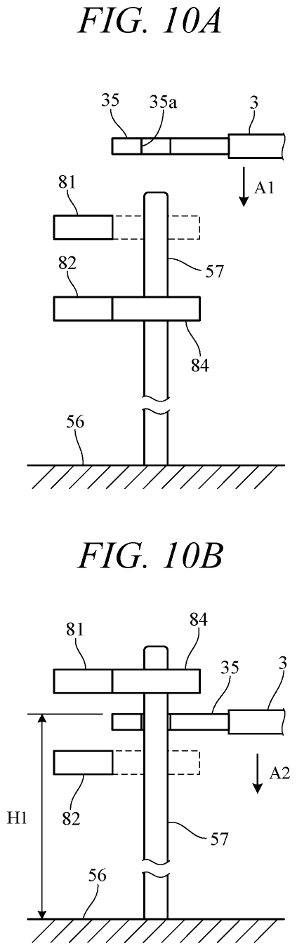

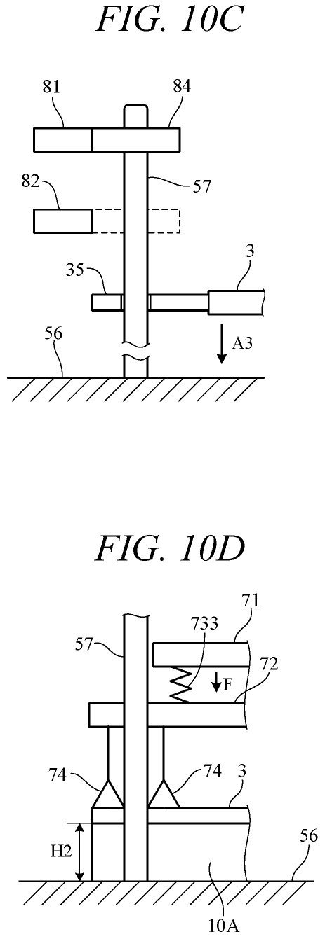

Accordingly, as illustrated in FIG. 10A, the separator 3 (strictly speaking, the unit cell integrated with the unitized electrode assembly 2) moves toward an arrow A1 direction, and the separator 3 descends along the assembly shaft 57, while the assembly shaft 57 is being inserted into the through-hole 35a of the tab 35 of the separator 3. At this stage, the assembly shaft 57 is held by the lower grip 82, thereby preventing the assembly shaft 57 having a long size from deflecting. This enables the separator 3 to smoothly descend without the through-hole 35a of the separator 3 being caught by the assembly shaft 57. In addition, the lever 84 of the upper grip 81 is located in the open position, and thereby enabling the separator 3 to descend to a position below the upper grip 81 without interfering with the upper grip 81.

Next, in step S4, the ECU 90 determines whether the suction unit 70 has reached a predetermined position, based on the signal from the angle sensor 91. In other words, as illustrated in FIG. 10B, the ECU 90 determines whether the separator 3 (the suction surface 741a) has reached the predetermined position above the base 56 by a predetermined height H1. The predetermined position is a position where the separator 3 and the suction unit 70 (the pipe 76 and the piping 77 of the protrusion portion 75) are located below the upper grip 81 and above the lower grip 82. At the predetermined position, the upper and lower grips 81 and 82 can be opened and closed without interfering with the separator 3 and the suction unit 70. When a negative determination is made in step S4, the processing returns to step S3, and the suction unit 70 continuously descends. When an affirmative determination is made in step S4, the processing proceeds to step S5.

In step S5, the ECU 90 outputs a control signal to the robot actuator 92 to stop the suction unit 70 descending. Next, in step S6, the ECU 90 outputs a control signal to the gripping actuator 93 of the upper grip 81 to move the lever 84 of the upper grip 81 to the closed position, as illustrated in FIG. 10B (moving step). Next, in step S7, the ECU 90 outputs a control signal to the gripping actuator 93 of the lower grip 82 to move the lever 84 of the lower grip 82 to the open position, as illustrated in FIG. 10B (moving step).

Next, in step S8, the ECU 90 outputs a control signal to the robot actuator 92, and causes the suction unit 70 to descend with the position of the suction unit 70 (for example, the suction pad 74) kept constant in the front-rear direction and the left-right direction, while grasping the current position of the suction unit 70, based on the signal from the angle sensor 91. This causes the separator 3 to descend along the assembly shaft 57, as indicated by an arrow A2 in FIG. 10B. At this stage, the assembly shaft 57 is held by the upper grip 81, thereby preventing the assembly shaft 57 having the long size from deflecting. This enables the separator 3 to smoothly descend without the through-hole 35a of the separator 3 being caught by the assembly shaft 57. In addition, the lever 84 of the lower grip 82 is located in the open position, thereby enabling the separator 3 to descend to a position below the lower grip 82 without interfering with the lower grip 82, as illustrated in FIG. 10C.

Next, in step S9, the ECU 90 determines whether the suction unit 70 has reached a target position, based on the signal from the angle sensor 91, that is, whether the separator 3 has reached the target position by the separator 3 moving in an arrow A3 direction in FIG. 10C. As illustrated in FIG. 10D, the target position corresponds to the position of the upper surface of the stacked body that has been already stacked (the stacked body before the stacking step is completed, and this will be referred to as a pre-completion stacked body) 10A, and a position above the base 56 by a target height H2 is the target position. The ECU 90 calculates the target height H2, and also calculates the target position, based on the number of the separators 3 that have been already stacked (the number of the separators 3 included in the pre-completion stacked body 10A) and also in consideration of a total pressed amount due to the gravity of the pre-completion stacked body 10A.

More specifically, in a memory of the ECU 90, the thickness of the separator 3 per sheet (strictly speaking, the thickness of the unit cell per set) is stored beforehand, and a relationship between the number of the stacked separators 3 and the pressed amount is stored. By use of such a relationship, the target height H2 is calculated. The target height H2 increases, whenever the separator 3 is stacked.

There is an error in the thickness of the separator 3. Hence, the target position that has been calculated may be different from an actual upper surface position of the pre-completion stacked body 10A. In such a case, the upper surface of the pre-completion stacked body 10A may be pressed by the robot 60 through the separator 3 sucked by the suction pad 74. In this case, the spring 733 between the base plate 71 and the movable plate 72 is compressed. Accordingly, it becomes possible to prevent an excessive pressing load from acting on the suction pad 74, the separator 3 sucked by the suction pad 74, and the pre-completion stacked body 10A. In addition, the error in the thickness of the separator 3 can be absorbed by the spring 733. This eliminates the need for the ECU 90 to calculate the target position with accuracy.

When a negative determination is made in step S9, the processing returns to step S8, and the suction unit 70 continuously descends. When an affirmative determination is made in step S9, the processing proceeds to step S10. In step S10, the ECU 90 outputs a control signal to the vacuum generator 94 to turn off the vacuum generator 94. Thus, the suction of the separator 3 by the suction pad 74 is released (suction releasing step). In this case, the suction is released after the separator 3 abuts on the upper surface of the pre-completion stacked body 10A, so that the separator 3 can be favorably stacked on the upper surface of the pre-completion stacked body 10A in a state in which the separator 3 is positioned with accuracy, without free fall of the separator 3. The processing in step S1 to step S10 described above is processing until the separators 3 (unit cells) are stacked.

Next, the processing proceeds to step S11 in FIG. 9B, and processing of returning the suction unit 70 to the initial position is started. In step S11, the ECU 90 outputs a control signal to the robot actuator 92 to cause the suction unit 70 to ascend. In this situation, the lever 84 of the lower grip 82 is located in the open position, thereby enabling the suction unit 70 to move to a position above the lower grip 82 without interfering with the lower grip 82. Next, in step S12, whether the suction unit 70 (the suction surface 741a) has reached a predetermined position is determined. This determination is similar to step S4, and the predetermined position is set to a position between the upper grip 81 and the lower grip 82. When a negative determination is made in step S12, the processing proceeds to step S11, and the suction unit 70 continuously ascends. When an affirmative determination is made in step S12, the processing proceeds to step S13.

In step S13, the ECU 90 outputs a control signal to the robot actuator 92 to stop the suction unit 70 ascending. Next, in step S14, the ECU 90 outputs a control signal to the gripping actuator 93 of the lower grip 82 to move the lever 84 of the lower grip 82 to the closed position. Next, in step S15, the ECU 90 outputs a control signal to the gripping actuator 93 of the upper grip 81 to move the lever of the upper grip 81 to the closed position. In this situation, the suction unit 70 (the movable plate 72, the pipe 76, and the like) is located between the lower grip 82 and the upper grip 81, thereby enabling the grips 81 and 82 to be opened and closed without the suction unit 70 interfering with the upper grip 81 or the lower grip 82.

Next, in step S16, the ECU 90 outputs a control signal to the robot actuator 92 to cause the suction unit 70 to ascend. In this situation, the lever 84 of the upper grip 81 is located in the open position, thereby enabling the suction unit 70 to ascend without the suction unit 70 interfering with the upper grip 81. Next, in step S17, the ECU 90 determines whether the suction unit 70 has ascended to a predetermined detached position, based on the signal from the angle sensor 91. The detached position is a position where the movable plate 72 moves to an upper side than the upper end of the assembly shaft 57, and the through-hole 75a is detached from the assembly shaft 57. The detached position may be set to an identical position to the start descending position in step S2.

Next, in step S18, the ECU 90 outputs a control signal to the robot actuator 92 to move the suction unit 70 to the initial position above the tray. Heretofore, one cycle of the stacking step ends. Thereafter, identical processing is repeated until a predetermined number of the separators 3 (the unit cells) are stacked.

According to the present embodiment, the following operations and effects are achievable.

(1) An assembling method for a fuel cell stack includes stacking step of stacking a unitized electrode assembly 2 (membrane electrode structural body) including an electrolyte membrane and an electrode, and a separator 3 alternately on a base 56 that is a predetermined region to form a cell stacked body 10. The stacking step includes transporting step (step S2) of transporting the separator 3 above the predetermined region while sucking the separator 3 (strictly speaking, a unit cell in which the unitized electrode assembly 2 is integrally provided) by the suction pad 74, a descending step (step S3) of descending the separator 3 while positioning the separator 3 along the assembly shaft 57 extending upward around the predetermined region, and a suction releasing step (step S10) of releasing the suction by the suction pad 74 when the lower surface of the separator 3 abuts on the upper surface of another stack element (pre-completion stacked body 10A) which has been stacked in the predetermined region (FIG. 9A). In this assembling method, the robot 60 transports the separator 3 until the separator 3 comes into contact with the upper surface of the pre-completion stacked body 10A, rather than freely dropping the separator 3 along the assembly shaft 57. Therefore, even when the separator 3 is warped or undulated, the cell stacked body 10 can be formed with high accuracy without misalignment of the stacked position of the separators 3.

(2) The stacking step further includes a moving step (step S6, step S7) of moving (opening and closing) the levers 84 of the upper grip 81 and the lower grip 82 configuring the pair of upper and lower grip devices 80 having the levers 84 movably provided between the closed position (a first position) holding the assembly shaft 57 and the open position (a second position) separating from the assembly shaft 57 in accordance with the descent position of the separator 3 in the descending step (FIG. 9A). In the moving step, the lever 84 of the upper grip 81 is moved to the open position and the lever 84 of the lower grip 82 is moved to the closed position until the separator 3 descends to a predetermined position between the upper grip 81 and the lower grip 82 (FIGS. 9A and 10A). Then, when the separator 3 descends to the predetermined position, the lever 84 of the upper grip 81 is moved to the closed position, and the lever 84 of the lower grip 82 is moved to the open position (FIGS. 9A and 10B). Accordingly, when the separator 3 is descended along the assembly shaft 57, the elongated assembly shaft 57 is held by at least one of the upper grip 81 and the lower grip 82. Therefore, the deflection of the assembly shaft 57 can be prevented, and the separator 3 can be smoothly descended to the target position along the assembly shaft 57.

(3) In the descending step, the separator 3 is descended while supporting the suction pad 74 on the base plate 71 which is moved by the driving of the robot actuator 92 via the spring 733 which can be vertically contracted (FIG. 10D). Accordingly, it is possible to prevent an excessive load from acting on the pre-completion stacked body 10A by the robot 60 that transports the separator 3. Therefore, even when there is an error in the stacked position of the separators 3, the separator 3 can be lowered to the target position satisfactorily.

(4) The stacking apparatus 50 is configured to form the cell stacked body 10 by stacking the separator 3 on the base 56 as a predetermined region. The stacking apparatus 50 includes: the suction unit 70, which includes the suction pad 74 for sucking the separator 3, and which is provided to be capable of ascending and descending; the assembly shaft 57, which is extended upward around the predetermined region, and which regulates the position of the edge portion of the separator 3 when the suction unit 70 descends; the robot actuator 92, which causes the suction unit 70 to ascend and descend via the robot 60; the vacuum generator 94, which generates the suction force on the suction pad 74; and the ECU 90, which controls the vacuum generator 94 and the robot actuator 92 (FIGS. 4 and 8). The ECU 90 controls the robot actuator 92 so that the suction unit 70 moves to a target position where the lower surface of the separator 3 abuts on the upper surface of another stack element (the pre-completion stacked body 10A) that has been stacked in the predetermined region, and also controls the vacuum generator 94 to release the suction of the separator 3, when the suction unit 70 moves to the target position (FIG. 9A). Accordingly, even in a case where the separator 3 warps or undulates, the cell stacked body 10 can be configured with high accuracy without positional displacement of the separator 3.

(5) The stacking apparatus 50 further includes: the upper grip 81 and the lower grip 82, which is included in the grip device 80 including the pair of upper and lower levers 84 each provided to be movable between the closed position for holding the assembly shaft 57 and the open position separated from the assembly shaft 57; the gripping actuator 93, which drives opening and closing of the upper grip 81 and the lower grip 82; and the angle sensor 91, which detects the descent position of the separator 3 (FIG. 8). Furthermore, the ECU 90 controls the gripping actuator 93 to move the lever 84 of the upper grip 81 to the open position and the lever 84 of the lower grip 82 to the closed position, until the descent position of the separator 3 detected by the angle sensor 91 reaches the predetermined position between the upper grip 81 and the lower grip 82, and to move the lever 84 of the upper grip 81 to the closed position and the lever 84 of the lower grip 82 to the open position, when the descent position reaches the predetermined position (FIG. 9A). Accordingly, when the separator 3 is caused to descend along the assembly shaft 57, deflection of the assembly shaft 57 can be prevented, so that the separator 3 can be mounted on the upper surface of the pre-completion stacked body 10A with high accuracy.

(6) The suction unit 70 further includes: the base plate 71, which ascends and descends in accordance with driving of the robot actuator 92; and the plate support portion 73, which supports the suction pad 74 from the base plate 71 via the spring 733 so as to be relatively movable in the up-down direction (FIG. 4). Accordingly, when the separator 3 is mounted on the upper surface of the pre-completion stacked body 10A by use of the robot 60, an excessive load can be prevented from acting on the pre-completion stacked body 10A.

(7) The stacking apparatus 50 further includes the pipe 76, which has the lower end surface 76a extending on an identical plane to the suction surface 741a of the suction pad 74, and which surrounds the suction pad 74 (FIG. 6). This enables the separator 3 to descend along the assembly shaft 57 in a state in which the warpage and undulation of the separator 3 are corrected, so that the separator 3 can make a smooth descending movement.

The above-described embodiment can be varied into various forms. Some variations will be described below. In the above-described embodiment, the unitized electrode assembly 2 and the separator 3 are integrated to form a unit cell in advance, and then the separator 3 is sucked, but the unitized electrode assembly 2 and the separator 3 may be alternately sucked without integrating the unitized electrode assembly 2 and the separator 3. That is, either one of a unitized membrane electrode and a separator as a stack element may be sucked, or both may be sucked at once. In the above-described embodiment, the ECU 90 controls on and off of the vacuum generator 94 to control the operation of the suction pad 74 as a suction portion. That is, the ECU 90 and the vacuum generator 94 are used as a control unit for controlling the suction portion, but the configuration of the control unit is not limited to this.

In the above-described embodiment, the assembly shaft 57 as a guide member is erected from the upper surface of the base 56, but may be erected from the lower end unit 20. In this case, the guide member may be pulled out from above after the pressurizing step or after the fastening step. In the above-described embodiment, the assembly shaft 57 is configured to have a substantially cylindrical shape, and the assembly shaft 57 is inserted into the through-hole 35a of the tab 35 of the separator 3, but the guide member is not limited to the cylindrical shape as long as it restricts the position of the edge portion of the separator. For example, the separator 3 may be provided with a concave portion or a convex portion at an edge portion of the separator 3 and the guide member may be configured to engage with the concave portion or the convex portion. The guide member may be protruded upward from the upper surface of the lower end unit 20 and be stored in the case 30 serving as an element of the fuel cell stack 100.

In the above-described embodiment, the assembly shaft 57 is erected around the base 56, and a stack element such as the separator 3 is stacked on the base, but the predetermined region in which the stacking process is performed is not limited to the above-described region. In the above-described embodiment, the suction unit 70 is provided so as to be movable up and down, but the configuration of a movable part including the suction portion is not limited to the above-described configuration. In the above-described embodiment, the suction unit 70 is transported, and ascended and descended by the robot actuator 92, but it may be transported, and ascended and descended without passing through the robot 60, and the configuration of an actuator (a first actuator) for ascending and descending the movable part is not limited to the above-described configuration.

In the above-described embodiment, the grip device 80 having the pair of upper and lower and the openable and closable levers 84 is configured as a guide support portion. That is, although the upper grip 81 and the lower grip are configured as a upper guide support portion and a lower guide support portion, respectively, the configuration of a guide support portion is not limited to those described above. Thus, the first position may not be the closed position of the lever 84 and the second position may not be the open position of the lever 84. The configuration of the gripping actuator 93 (a second actuator) is not limited to the configuration described above.

In the above-described embodiment, the descent position of the separator 3 is detected based on the signal from the angle sensor 91, but the descent position may be detected using another sensor, and the configuration of a position detection portion is not limited to this. In the above-described embodiment, the suction pad 74 is supported through the plate support portion 73 from the base plate 71 so that the suction pad 74 is movable relative to the base plate 71. That is, although the suction pad 74 is supported from the base plate 71 (a base portion) of the suction unit 70 via the spring 733 as an elastic body so as to be relatively movable in the up-down direction, the configuration of a support portion is not limited thereto. In the above-described embodiment, the pipe 76 (a tubular body) is provided so as to surround the suction pad 74, but the configuration of the tubular body is not limited to the above-described configuration. In the above-described embodiment, the pair of front and rear pipes 76 are disposed in the protrusion portions 75 of the movable plate 72, but the pipe 76 may be disposed outside a rotation range of the lever 84. This prevents interference between the lever 84 and the pipe 76 regardless of the ascent and descent position of the movable plate 72.

In the above-described embodiment, the cell stacked body 10 of the fuel cell stack 100 is configured by using the stacking apparatus 50, but a stacking apparatus of the present invention can be similarly applied to the case where the stack elements are stacked while being positioned to configure other stacked body.

The above embodiment can be combined as desired with one or more of the above modifications. The modifications can also be combined with one another.

According to the present invention, even in a case where a separator warps or undulates, it is possible to stack the separator with high accuracy without the separator being caught by an assembly shaft or the like.

Above, while the present invention has been described with reference to the preferred embodiments thereof, it will be understood, by those skilled in the art, that various changes and modifications may be made thereto without departing from the scope of the appended claims.

What is claimed is:

1. An assembling method for a fuel cell stack, comprising
stacking alternately a unitized electrode assembly having an electrolyte membrane and an electrode, and a separator in a predetermined region to form a cell stacked body, wherein
each of the unitized electrode assembly and the separator is a stack element, and
the stacking includes:
transporting the stack element above the predetermined region while sucking the stack element by a suction portion:
descending the stack element while positioning the stack element along a guide member extending upward around the predetermined region; and
releasing a suction by the suction portion when a lower surface of the stack element abuts on an upper surface of another stack element having been stacked in the predetermined region.

2. The assembling method according to claim 1, wherein
the stacking further includes moving an upper guide support portion and a lower guide support portion provided movably between a first position holding the guide member and a second position separated from the guide member, in accordance with a descent position of the stack element during the descending, and
the moving includes moving the upper guide support portion to the second position and the lower guide support portion to the first position until the stack element descends to a predetermined position between the upper guide support portion and the lower guide support portion, and moving the upper guide support portion to the first position and the lower guide support portion to the second position when the stack element descends to the predetermined position.

3. The assembling method according to claim 1, wherein
the descending includes descending the stack element, while supporting the suction portion at a base portion moving in accordance with driving of an actuator through an elastic body contractible in an up-down direction.

4. The assembling method according to claim 1, further comprising
joining the unitized electrode assembly and the separator in advance to form a unit cell, wherein
the stacking includes sucking the unit cell by the suction portion.

5. A stacking apparatus configured to form a stacked body by stacking a stack element in a predetermined region, the stacking apparatus comprising:
a movable part provided vertically movably and including a suction portion configured to suck the stack element;
a guide member extended upward around the predetermined region to regulate a position of an edge portion of the stack element when the movable part descends;
an actuator ascending and descending the movable part; and
an electronic control unit configured to control the suction portion and the actuator, wherein
the electronic control unit is configured to control the actuator so as to move the movable part to a target position where a lower surface of the stack element abuts on an upper surface of another stack element having been stacked in the predetermined region, and to control the suction portion so as to release sucking of the stack element when the movable part reaches the target position.

6. The stacking apparatus according to claim 5, wherein
the actuator is a first actuator,
the stacking apparatus further comprises:
an upper guide support portion and a lower guide support portion provided movably between a first position holding the guide member and a second position separated from the guide member;
a second actuator driving the upper guide support portion and the lower guide support portion; and
a position detection portion detecting a descent position of the stack element,
the electronic control unit is configured to further control the second actuator so as to move the upper guide support portion to the second position and the lower guide support portion to the first position until the descent position of the stack element detected by the position detection portion reaches a predetermined position between the upper guide support portion and the lower guide support portion, and to move the upper guide support portion to the first position and the lower guide support portion to the second position when the descent position reaches the predetermined position.

7. The stacking apparatus according to claim 5, wherein
the movable part further includes
a base portion ascending and descending in accordance with driving of the actuator, and
a support portion supporting the suction portion from the base portion through an elastic body in a movable manner in an up-down direction relative to the base portion.

8. The stacking apparatus according to claim 5, further comprising
a tubular body having a distal end face extending on an identical plane to a suction surface of the suction portion to surround the suction portion.

9. The stacking apparatus according to claim 5, wherein
the suction portion includes a first pair of suction portions and a second pair of suction portions,
the guide member includes a pair of guide members regulating a position of a first edge portion on a first end side of the stack element and a position of a second edge portion on a second end side of the stack element,
the first pair of suction portions are provided so that suction surfaces of the first pair of suction portions face an upper surface of the first edge portion, and
the second pair of suction portions are provided so that suction surfaces of the second pair of suction portions face an upper surface of the second edge portion.

10. The stacking apparatus according to claim 6, wherein
each of the upper guide support portion and the lower guide support portion includes a pair of openable levers closing at the first position so as to grip an outer peripheral surface of the guide member and opening at the second position so as to separate from the outer peripheral surface.
